(19) United States
(12) Patent Application Publication
(10) Pub. No.: US 2015/0149240 A1
(43) Pub. Date: May 28, 2015

(54) IDENTIFYING CONTROL IMPROVEMENT OPPORTUNITIES FOR KEY PROCESSES

(71) Applicant: BANK OF AMERICA CORPORATION, CHARLOTTE, NC (US)

(72) Inventors: Venkata Surya Narayana Raju Madiraju, Charlotte, NC (US); Subramanian Selvaraj Sulur, Charlotte, NC (US); Roland M. Felix, Vallejo, CA (US); Brandon Duane Hardie, Charlotte, NC (US)

(73) Assignee: BANK OF AMERICA CORPORATION, CHARLOTTE, NC (US)

(21) Appl. No.: 14/090,364

(22) Filed: Nov. 26, 2013

(51) Int. Cl. G06Q 10/06

(52) U.S. Cl. CPC G06Q 10/0635
USPC 705/7.28

(57) ABSTRACT

Embodiments of the invention are directed to apparatus, methods, and computer program products for identifying process control gaps and process control improvement opportunities in a financial institution. The present invention leverages both Failure Mode and Effects Analysis (FMEA), specifically implementation of a risk priority number/score and Federal Financial Institution Examination Council (FFIEC) examination guidelines, specifically completion of a process control guidance checklist to result in a process control status score. As a result of the integration of FMEA and FFIEC examination guidelines, a resulting risk-based process health score is implemented to identify the risk of lack of process controls or gaps in existing process controls. As a result, actions may be taken to mitigate the risk and/or provide the requisite process controls.

### FIELD

In general, embodiments of the invention relate to methods, systems, apparatus and computer program products for identifying control improvement opportunities for key process within a financial institution and, more specifically leveraging Failure Mode and Effects Analysis (FMEA) with a process health score that measures the current level of process control to determine if a control improvement opportunity exists (i.e., improve an existing control or develop a currently non-existing control).

### BACKGROUND

Business entities have many important processes which present risk to the business if a failure of the process was to occur. For example, in the financial institution scenario, such processes may involve Information Technology (IT) processes associated with identifying suspicious activity (e.g., the intent of individuals to launder money or otherwise commit illegal activities) within the financial institution. Paramount to such important or “key” processes is the ability to identify gaps in the control of the processes and/or opportunities to improve the control of the processes.

Many different approaches currently exist to analyze failure and assess the risk associated with a process. One such approach for failure analysis is Failure Mode and Effects Analysis (FMEA), which entails review of as many components, assemblies and subsystems as possible to identify failure modes and their causes and effects.

From the financial institution perspective, the Federal Financial Institution Examination Council (FFIEC) has prescribed uniform principles, standard and report forms for the federal examination of financial institutions by various different governing bodies, agencies and the like. Moreover, the FFIEC has promulgated the controls that need to be examined for IT and operations within a financial institution.

Therefore, a need exists for a standard, repeatable procedure for identifying process control gaps and opportunities for process control improvement. The desired procedure should be capable of being applicable to all IT and operations value chains, processes and steps within the processes. Moreover, the desired procedure should identify existing controls, such that control improvement opportunities can be readily identified. In addition, the desired procedure should provide the impetus for improving existing process controls and/or building new process controls.

### BRIEF SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for identifying process control limitations and process control opportunities through a standard, repeatable procedure that can be applied to all key process and steps within the process within a financial institution. In specific embodiments, the present invention leverages and integrates both the Failure Mode and Effects Analysis (FMEA) techniques for failure analysis and the Federal Financial Institution Examination Council (FFEIC) IT examination guidelines to create a risk based approach that determines process control improvement opportunities for the key process under examination.

An apparatus for identifying process control opportunities for key processes with a financial institution defines first embodiments of the invention. In specific embodiments the key processes are Information Technology (IT) processes associated with detecting suspicious activity within a financial institution. The apparatus includes a computing platform having a memory and at least one processor in communication with the memory. The apparatus further includes a process control opportunity module that is stored in the memory and executable by the processor. The module includes a risk priority routine that is configured to determine a risk priority number for a plurality of identified steps of a key process. The risk priority number is determined based on (1) cost of a failure mode associated with the step, (2) probability of the failure mode and (3) detectability of the failure mode. The module further includes a process health routine that is stored in the memory and executable by the processor. The process health module is configured to determine a process health score for each identified step of the key process, such that the process health score is based on the risk priority number and a process control status score that is determined for each of the identified steps based on a level of process control currently existing in a corresponding identified step. The module further includes a process control opportunity routine that is configured to identify a process control opportunity for one or more of the steps based on the process health score meeting or exceeding a predetermined threshold.

In specific embodiments of the apparatus, the process control status score is determined by providing entries into at least a portion of a process controls guidance checklist for each identified step of the key process and basing the process control status score on the entries provided. In such embodiments of the apparatus, providing entries into at least a portion of the process controls checklist further includes determining which categories of the process control checklist apply to the step and providing entries into queries associated with the determined categories. The categories include more than one of (1) resource management, (2) solution monitoring, (3) access controls, (4) process documentation, (5) management routines, (6) segregation of duties, (7) data quality, (8) completeness of controls, (9) escalation procedures and (10) privacy.

In other specific embodiments of the apparatus, the process control status score is determined by assigning a first score if a process control fully exists, assigning a second score if a process control partially exists and assigning a third score if a process control does not exist. In other related embodiments of the apparatus, the process control status score is determined by mapping each step to one or more links in a value chain. The value chain is a set of links, each link correlating to a data input and a data output of the key process.

In still further specific embodiments of the apparatus, the process health module is further configured to determine the process health score by multiplying the risk priority number by the process control status score.

A method for identifying process control opportunities for a key process within a financial institution defines second embodiments of the invention. In specific embodiments, the key processes are Information Technology (IT) processes associated with detecting suspicious activity within a financial institution. The method includes identifying a plurality of steps included in a key process and determining a risk priority number for each identified step of the key process. The risk priority number is determined based on (1) cost of a failure mode associated with the step, (2) probability of the failure mode and (3) detectability of the failure mode. The method further includes determining a process control status score for each step of the key process. The process control status score is determined based on a level of process control currently existing for a corresponding step. The method additionally includes determining a process health score for each step of the key process. The process health score is based on the risk priority number and the control status score. In addition, the method includes identifying a process control opportunity for one or more of the steps based on the process health score meeting or exceeding a predetermined threshold.

In specific embodiments of the method, determining the process control status score further includes providing entries into at least a portion of a process controls guidance checklist for each step of the key process and determining the process control status score based on the entries provided. In such embodiments of the method, providing entries into at least a portion of the process controls checklist further includes determining which categories of the process control checklist apply to the step. The categories include more than one of (1) resource management, (2) solution monitoring, (3) access controls, (4) process documentation, (5) management routines, (6) segregation of duties, (7) data quality, (8) completeness of controls, (9) escalation procedures and (10) privacy.

In other specific embodiments of the method, determining the process control status score further includes assigning a first score if a process control fully exists, assigning a second score if a process control partially exists and assigning a third score if a process control does not exist. In other related embodiments of the method, determining the process control status score further includes mapping each step to one or more links in a value chain. The value chain is a set of links, each link correlating to a data input and a data output of the key process.

In still further specific embodiments of the method, determining the process health score further comprises multiplying the risk priority number by the process control status score.

A computer program product including a non-transitory computer-readable medium defines third embodiments of the invention. The computer readable medium includes a first set of codes for causing a computer to determine a risk priority number for a plurality of identified steps of a key process. The risk priority number is determined based on (1) cost of a failure mode associated with the step, (2) probability of the failure mode and (3) detectability of the failure mode. The computer-readable medium additionally includes a second set of codes for causing a computer to determine a process health score for each identified step of the key process. The process health score is based on the risk priority number and a process control status score that is determined for each of the identified steps based on a level of process control currently existing in a corresponding identified step. In addition, the computer-readable medium includes a third set of codes for causing a computer to identify a process control opportunity for one or more of the steps based on the process health score meeting or exceeding a predetermined threshold.

Thus, embodiments of the present invention, which are described in more detail below, provide for identifying process control gaps and process control improvement opportunities. The present invention leverages both FMEA, specifically implementation of a risk priority number/score and FFIEC examination guidelines, specifically completion of a process control guidance checklist to result in a process control status score. As a result of the integration of FMEA and FFIEC examination guidelines, a resulting risk-based process health score is implemented to identify the risk of lack of process controls or gaps in existing process controls. As a result, actions may be taken to mitigate the risk and/or provide the requisite process controls.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 is a block diagram representation of an apparatus for identifying process control opportunities for key processes in a financial institution, in accordance with embodiments of the present invention;

FIG. 2 is a flow diagram of a method for identifying process control opportunities for key processes within a financial institution, in accordance with embodiments of the present invention; and

FIG. 3 is a more detailed flow diagram of a methodology for identifying process control opportunities for key processes within a financial institution, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Furthermore, the term “product” or “account” as used herein may include any financial product, service, or the like that may be provided to a customer from an entity that subsequently requires payment. A product may include an account, credit, loans, purchases, agreements, or the like between an entity and a customer. The term “relationship” as used herein may refer to any products, communications, correspondences, information, or the like associated with a customer that may be obtained by an entity while working with a customer. Customer relationship data may include, but is not limited to addresses associated with a customer, customer contact information, customer associate information, customer products, customer products in arrears, or other information associated with the customer's one or more accounts, loans, products, purchases, agreements, or contracts that a customer may have with the entity.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that investigate suspicious activity.

Thus, systems, apparatus, methods and computer program programs are herein described for identifying process control limitations and process control opportunities through a standard, repeatable procedure that can be applied to any key process within a financial institution. In specific embodiments, the present invention leverages and integrates both the Failure Mode and Effects Analysis (FMEA) techniques for failure analysis and the Federal Financial Institution Examination Council (FFIEC) IT examination guidelines to create a risk based approach that determines process control improvement opportunities for the key process under examination. Specifically, FMEA is utilized to quantify the risk priority (i.e., a risk priority number) associated with failure modes attributed to steps within a key process and a comprehensive FFIEC-based controls guidance checklist is implemented to assist in determining a process control status score. The risk priority number and the process control status score are integrated to result in process health score, which is used as the determining factor in identifying process control gaps and/or opportunities.

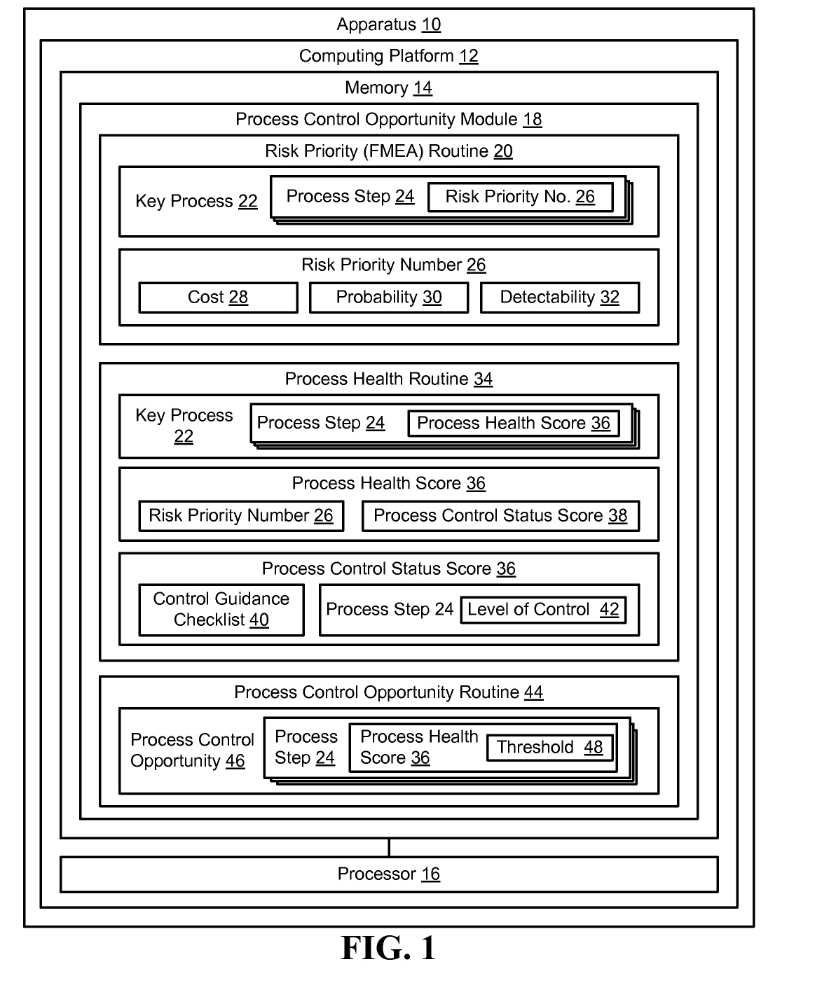

Referring to FIG. 1, presented is a block diagram of an apparatus 10 for identifying process control opportunities for key processes within a financial institution, in accordance with embodiments of the present invention. The apparatus 10, which may include more than device, includes a computing platform 12 that can receive and execute routines and applications and includes a memory 14 which is in communication with processor 16. The memory 14, which may comprise volatile and non-volatile memory, such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Processor 16, which may be an application-specific integrated circuit (“ASIC”), or other chipset, processor, logic circuit, or other data processing device. Processor 16 or other processor such as ASIC may execute an application programming interface (“API”) (not shown in FIG. 1) that interfaces with any resident programs, such as process control opportunity module 18 or the like stored in the memory 14 of the apparatus 10. Processor 14 may include various processing subsystems (not shown in FIG. 1) embodied in hardware, firmware, software, and combinations thereof, that enable the functionality of apparatus 10 and the operability of the apparatus on a network. For example, processing subsystems allow for initiating and maintaining communications and exchanging data with other networked devices. For the disclosed aspects, processing subsystems of processor 16 may include any subsystem used in conjunction with process control opportunity module 18 or subcomponents or sub-modules thereof.

Memory 14 stores process control opportunity module 18 that is executable by processor 16 and configured to identify process control opportunities for key financial institution processes and, specifically, steps within those processes. The module 18 includes risk priority routine 20 that is configured to determine a risk priority number 26 (otherwise, referred to as a risk priority score) for each identified process step 24 of a key process 22 within a financial institution. The key process 22 may be any process within a financial institution that generates risk. For example, in specific embodiments of the invention, the key processes may be Information Technology (IT) and/or operations related, such as automated systems to identify suspicious activity (i.e., financial transactions that identify the intent of individuals to launder money or otherwise conduct illegal activities).

The risk priority number 26, which is part of Failure Mode and Effects Analysis (FMEA), is based on the (a) cost 28 (otherwise referred to as impact or severity) associated with an occurrence of a failure mode; (b) the probability 30 (otherwise referred to as the likelihood) of an occurrence of a failure mode; and (c) the detectability 32 (otherwise referred to as the preventability) of the failure mode. In specific embodiments, a number is assigned to each of cost 28, probability 30 and detectability 32 based on the relative level of each as it pertains to the failure mode. The rating scale may be six sigma-based (i.e., 1=low level, 3=medium level and 9=high level). The numbers assigned to each of cost 28, probability 30 and detectability 32 are multiplied to result in the risk priority number 28. Thus, the higher the risk priority number, the higher the overall risk of the failure mode.

The process control opportunity module 18 additionally includes process health routine 34 that is configured to determine a process health score 36 for each identified process step 24 of the key process 22. The process health score 36 is based on the risk priority number 26 and a process control status score 38. In specific embodiments, the process health score 36 is calculated by multiplying the risk priority number 26 by the process control status score 38.

The process control status score 38 is a measurement of the level of process control 40 currently existing in the corresponding process step 24. In specific embodiments of the invention, the process control status score 38 is determined by completing those portions of a controls guidance checklist 40 that are applicable to the corresponding step. The controls guidance checklist is based the FFIEC guidelines as well as the experience and knowledge of the financial institution. In specific embodiments of the invention, the controls guidance checklist may include a plurality of question categories, including, but not limited to, (a) resource management; (b) solution monitoring; (c) access controls; (d) process documentation; (e) management routines; (f) segregation of duties; (g) data quality; (h) completeness; (i) escalation procedures; and (j) privacy. Based on the results of applicable portions of the checklist 40 a process control status score 38 is assigned to the step that quantifies the level of process control 40. For example, in specific embodiments of the invention, a first score is assigned if the process control fully exists, a second score is assigned if process control partially exists and a third score is assigned if process control does not exist (e.g., the first score=1, the second score=3 and the third score=5).

The process control opportunity module 18 additionally process control opportunity routine 44 that is configured to identify one or more process steps within a key process that are process control opportunities 46 (i.e., either no process control exists or a gap exists in the process control that requires process control improvement). In specific embodiments of the invention, the process control opportunity 46 is identified by comparing the process health score 36 to a predetermined threshold 48, such that process control opportunity 46 is identified if the process health score 36 meets or exceeds the predetermined threshold 48.

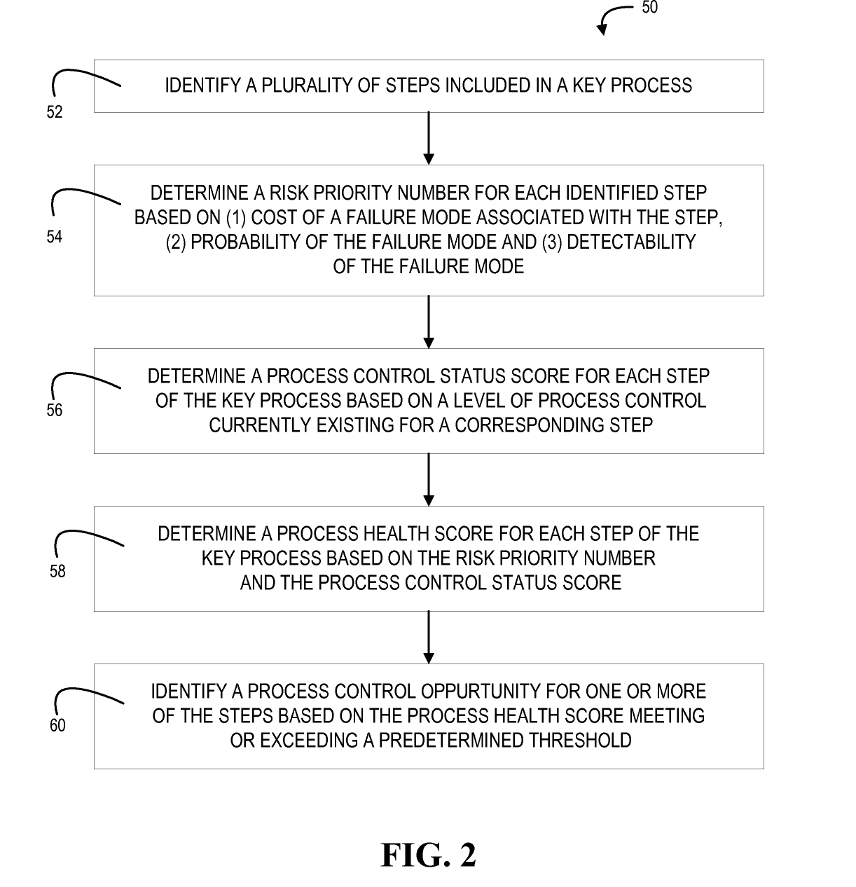

FIG. 2 is a flow diagram of a method 50 for identifying process control opportunities for key processes within a financial institution, in accordance with further embodiments of the invention. At Event 52, process documents associated with a key process are reviewed to understand the process and identify the key process steps. The key process may be any process that generates risk for the financial institution, for example, an IT and/or operations procedure or the like. In specific embodiments, appropriate subject matter experts may be relied upon to assist in the identification of the key process steps.

At Event 54, as part of an FMEA-type analysis of the key process steps, a risk priority number is determined for each identified key process step. The risk priority number indicates the overall risk associated with the failure mode. The risk priority number determination is based on (1) costs associated with a failure mode; (2) likelihood of the failure mode and (3) probability of detection of the failure mode. In specific embodiments a rating number that indicates a level is assigned to each of cost, likelihood and detectability and the rating numbers are multiplied to result in the product; i.e., the risk priority number for the key process step.

At Event 56, a process control status score is determined for each key process step. The process control status score is determined based on the level of process control currently existing for each key process step. In specific embodiments, a controls guidance checklist/questionnaire is implemented to assess the level of process controls currently existing. The controls guidance checklist/questionnaire is based on the experience/knowledge of the process owners, as well as the guidelines/standards of the FFIEC. For each key process step applicable portions/categories of the checklist will be identified and completed to assess the current level of process controls. Based on completion of the checklist and other relevant information, such as which link(s) to a value chain belongs to the process step, a process control status score is assigned to the key process step. In one specific embodiment the process control status score may one of three different scores, for example a first score may be associated with full process control currently existing, a second score associated with partial process control currently existing and a third score associated with no process control currently existing.

At Event 58, a process health score is determined for each key process step based on the risk priority number and the process control status score. In specific embodiments, the process health score may be calculated by multiplying the risk priority number (FMEA-based) by the process control status score (FFIEC-based) to result in the process health score, thereby integrating both the FMEA analysis process and the FFIEC guidelines to create a standard and reliable means to identify process control gaps/limitations.

At Event 60, process control opportunities are identified for one or more key process steps based on comparing the process health score to a predetermined threshold. If the process health score meets or exceeds the predetermined threshold a process control opportunity is identified. The process control opportunity may identify a need to construct a new process control and/or improve an existing process control. In specific embodiments of the invention, a report is generated detailing current controls and the need for process control opportunities and a high-level action plan including milestones is generated to address the key process control opportunities.

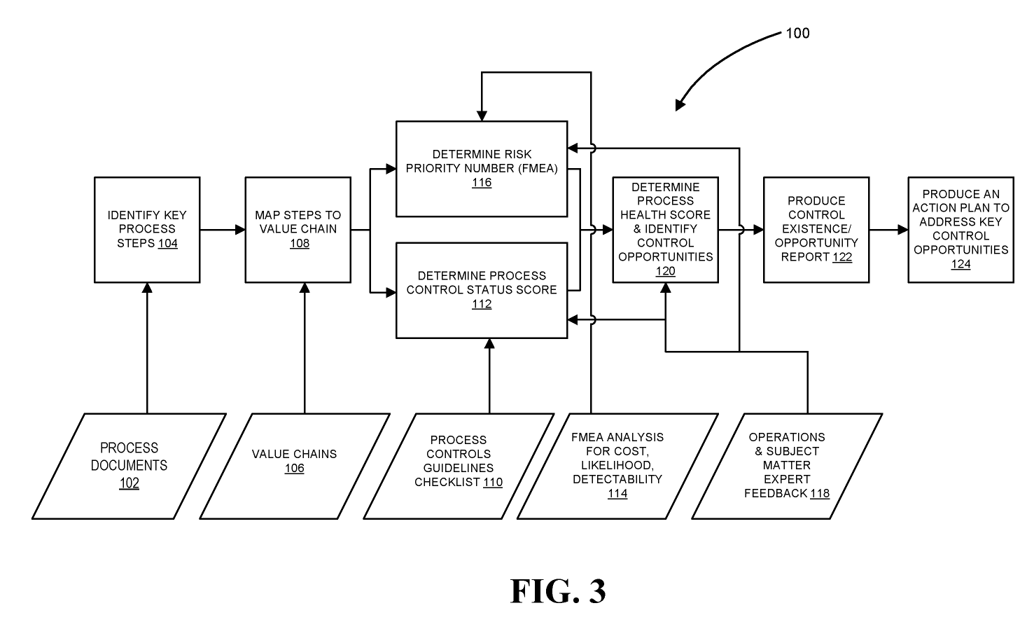

FIG. 3 presents a more detailed flow diagram of a method 100 for identifying process control opportunities, in accordance with alternate embodiments of the present invention, At Data Input 102, process documents are retrieved from an official document repository or other storage location. In addition, other documentation may be provided by a process owner or the like. At Event 104, the process documents are reviewed to identify the key process steps. The key process steps are those steps in the process indicate a failure risk for the financial institution. Subject matter experts may additionally be relied upon to assess the process documents and/or identify key process steps.

At Data Input 106, value chain(s) associated with the key process are retrieved from an official document repository or other storage location. The value chain shows the cause (input) and effect (output), collectively referred to as a link, of various processes or process steps within a business, for example, a financial institution. In other words, what process or process step has a downstream or upstream effect on other processes or process steps. At Event 108, links in the value chain are mapped to key process steps.

At Data Input 110, portions of the process control guideline checklist that are applicable to the key process step are completed. At Event 112, a process control status score is determined based on the results provided by the checklist and operations/subject matter expert feedback (Data Input 118). The process control status score provides a quantifiable indication of the level of process control that currently exists for the key process steps.

At Data Input 114, FMEA-type analysis is performed to assess cost of failure mode, likelihood of failure mode and detectability of failure mode. At Event 116, a risk priority number is determined for each of the key process steps based on the risk rating applied to the cost of failure mode, likelihood of failure mode and detectability of failure mode.

At Event 120, a process health score is determined by integrating the risk priority number/score and the process control status score and process control opportunities are identified based at least in part on the process health score. At Data Input 118, additional feedback from operations and/or subject matter experts may be received to add, subtract or alter the process control opportunities identified by the process health score.

At Event 122, a control existence and opportunity report is generated and disseminated and, at Event 124, an action plan and associated milestones are generated to address key process control opportunities.

Thus, as described in detail above, the present invention provides for apparatus, systems, computer program products and methods for identifying process control gaps and process control improvement opportunities. The present invention leverages both FMEA, specifically implementation of a risk priority number/score and FFIEC examination guidelines, specifically completion of a process control guidance checklist to result in a process control status score. As a result of the integration of FMEA and FFIEC examination guidelines, a resulting risk-based process health score is implemented to identify the risk of lack of process controls or gaps in existing process controls. As a result, actions may be taken to mitigate the risk and/or provide the requisite process controls.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for identifying process control opportunities for key processes with a financial institution, the apparatus comprising:
a computing platform having a memory and at least one processor in communication with the memory; and
a process control opportunity module stored in the memory, executable by the processor and including:
a risk priority routine configured to determine a risk priority number for a plurality of identified steps of a key process, wherein the risk priority number is determined based on (1) cost of a failure mode associated with the step, (2) probability of the failure mode and (3) detectability of the failure mode;
a process health routine configured to determine a process health score for each identified step of the key process, wherein the process health score is based on the risk priority number and a process control status score that is determined for each of the identified steps based on a level of process control currently existing in a corresponding identified step, and
a process control opportunity routine configured to identify a process control opportunity for one or more of the steps based on the process health score meeting or exceeding a predetermined threshold.

2. The apparatus of claim 1, wherein the process control status score is determined by providing entries into at least a portion of a process controls guidance checklist for each identified step of the key process and basing the process control status score on the entries provided.

3. The apparatus of claim 2, wherein providing entries into at least a portion of the process controls checklist further includes determining which categories of the process control checklist apply to the step, wherein the categories include more than one of (1) resource management, (2) solution monitoring, (3) access controls, (4) process documentation, (5) management routines, (6) segregation of duties, (7) data quality, (8) completeness of controls, (9) escalation procedures and (10) privacy.

4. The apparatus of claim 1, wherein the process control status score is determined by assigning a first score if a process control fully exists, assigning a second score if a process control partially exists and assigning a third score if a process control does not exist.

5. The apparatus of claim 1, wherein the process health routine is further configured to determine the process health score by multiplying the risk priority number by the process control status score.

6. The apparatus of claim 1, wherein the risk priority is further configured to determine the risk priority number for the plurality of identified steps of the key process, wherein the key process is associated with determining suspicious activity within a financial institution.

7. The apparatus of claim 1, wherein the process control status score is determined by mapping each step to one or more links in a value chain, wherein the value chain is set of links, each link correlating to a data input and a data output of the key process.

8. A method for identifying process control opportunities for key processes within a financial institution, the method comprising:
identifying a plurality of steps included in a key process;
determining, by a computing device processor, a risk priority number for each identified step of the key process, wherein the risk priority number is determined based on (1) cost of a failure mode associated with the step, (2) probability of the failure mode and (3) detectability of the failure mode;
determining a process control status score for each step of the key process, wherein the process control status score is determined based on a level of process control currently existing for a corresponding step;
determining, by a computing device processor, a process health score for each step of the key process, wherein the process health score is based on the risk priority number and the control status score; and
identifying, by a computing device processor, a process control opportunity for one or more of the steps based on the process health score meeting or exceeding a predetermined threshold.

9. The method of claim 8, wherein determining the process control status score further comprises providing entries into at least a portion of a process controls guidance checklist for each step of the key process and determining the process control status score based on the entries provided.

10. The method of claim 9, wherein providing entries into at least a portion of the process controls checklist further comprises determining which categories of the process control checklist apply to the step, wherein the categories include more than one of (1) resource management, (2) solution monitoring, (3) access controls, (4) process documentation, (5) management routines, (6) segregation of duties, (7) data quality, (8) completeness of controls, (9) escalation procedures and (10) privacy.

11. The method of claim 8, wherein determining the process control status score further comprises assigning a first score if a process control fully exists, assigning a second score if a process control partially exists and assigning a third score if a process control does not exist.

12. The method of claim 8, wherein determining the process health score further comprises multiplying the risk priority number by the process control status score.

13. The method of claim 8, wherein identifying the steps included in the key process further comprises identifying the steps included in the key process, wherein the key process is associated with determining suspicious activity within a financial institution.

14. The method of claim 8, wherein determining the process control status score further comprises mapping each step to one or more links in a value chain, wherein the value chain is set of links, each link correlating to a data input and a data output of the key process.

15. A computer program product comprising:
a non-transitory computer-readable medium comprising:
a first set of codes for causing a computer to determine a risk priority number for a plurality of identified steps of a key process, wherein the risk priority number is determined based on (1) cost of a failure mode associated with the step, (2) probability of the failure mode and (3) detectability of the failure mode;
a second set of codes for causing a computer to determine a process health score for each identified step of the key process, wherein the process health score is based on the risk priority number and a process control status score that is determined for each of the identified steps based on a level of process control currently existing in a corresponding identified step; and
a third set of codes for causing a computer to identify a process control opportunity for one or more of the steps based on the process health score meeting or exceeding a predetermined threshold.

16. The computer program product of claim 15, wherein the second set of codes is further configured to cause the computer to determine the process health score by multiplying the risk priority number by the process control status score.

17. The computer program product of claim 15, wherein the first set of codes is further configured to determine the risk priority number for the plurality of identified steps of the key process, wherein the key process is associated with determining suspicious activity within a financial institution.
